(19) United States
(12) Patent Application Publication
(10) Pub. No.: US 2020/0207462 A1
(43) Pub. Date: Jul. 2, 2020

(54) DRONE WITH FUNCTION OF REVERSE PROPULSION FOR BALANCING

(71) Applicant: Dong Chul KIM, Jeju-si, Jeju-do (KR)

(72) Inventor: Dong Chul KIM, Jeju-si, Jeju-do (KR)

(21) Appl. No.: 16/615,734

(22) PCT Filed: Nov. 29, 2018
(86) PCT No.: PCT/KR2018/014891

§ 371 Date: Nov. 21, 2019

(30) Foreign Application Priority Data
Jan. 17, 2018 (KR) 10-2018-0005937
Nov. 28, 2018 (KR) 10-2018-0149445

(51) Int. Cl. B64C 17/02; B64C 39/02; B64D 9/00; B64C 27/10; G01S 17/08; G01S 17/933

(52) U.S. Cl. CPC B64C 17/02; B64C 39/024; B64D 9/003; B64C 2201/108; G01S 17/08; G01S 17/933; B64C 2201/027; B64C 27/10

(57) ABSTRACT

A drone according to the present invention comprises one or more reverse thrust propeller units for generating reverse thrust and, when an operation such as the horizontal delivery of an object is performed, quickly offsets the movement of the center of gravity by using the force of reverse thrust such that the force applied to each propeller can be balanced. Propeller supports having the reverse thrust propeller units mounted thereon can be formed such that the lengths thereof can be extended and reduced. Since rotational force applied to each propeller motor can be equally distributed, stable flight can be promoted, and the risk of crash produced according to the application of excessive force can be reduced. Therefore, the present invention is applied to various fields in which the center of gravity changes because of load applied to one side, and thus stable operation of the drone can be promoted.

### TECHNICAL FIELD

The present invention relates to a drone, and more particularly, to a drone which can keep a balance using a reverse thrust propeller when the center of gravity is changed due to various loads applied to the drone.

### BACKGROUND ART

In general, a drone means an unmanned aerial vehicle, and is applied not only for military uses but also in various fields.

There are fields that a load of an object loaded on the drone have great effect on the drone, and for example, there is a parcel delivery service to directly deliver the object to consumers.

In general, the drone is not changed in the center of gravity once taking a balance in the center of gravity, but in case of the parcel delivery service, the load of the object delivered may cause movement of the center of gravity of the drone.

So, in the parcel delivery service using the drone, a vertical delivery method to vertically put down an object at a destination has been proposed.

However, the vertical delivery method is available in countries with a large land like the United States but is not suitable for countries with many apartments like Korea because it is to take down an object in a yard of a detached house.

A delivery man can take down an object on a handrail of an apartment horizontally when executing the parcel delivery service using the drone in a country with many apartments. That is, a method (horizontal delivery) to hang the object on the handrail or put the object in a delivery basket mounted on the handrail may be used.

However, during the horizontal delivery, the center of gravity of the drone may be moved severely.

If the drone leans due to movement of the center of gravity by the object, a motor of the leaned side receives great power, and increases battery consumption even though bearing the power. Moreover, the drone may fall if it cannot bear the movement of the center of gravity leaning to one side by the object.

Such a problem may occur not only in such a general parcel delivery service but also in various fields needing horizontal delivery of an object, for instance, when it is necessary to deliver relief goods to people under emergency situations, such as a fire on a building.

Therefore, various drone service fields that the center of gravity of the drone is moved severely due to a demand of horizontal delivery of an object need to keep a balance by rapidly offsetting the movement of the center of gravity.

### DISCLOSURE

### Technical Problem

Accordingly, the present invention has been made in view of the above-mentioned problems occurring in the prior art, and it is an object of the present invention to provide a drone having a reverse thrust balancing function which can keep a balance by rapidly offsetting movement of the center of gravity using reverse thrust when the center of gravity of the drone is moved.

### Technical Solution

To accomplish the above object, according to the present invention, there is provided a drone having a reverse thrust balancing function including: at least one reverse thrust propeller unit for generating reverse thrust force; and a flight control unit for controlling rotational speed of the reverse thrust propeller unit according to a change in the center of gravity.

Moreover, a propeller support on which the reverse thrust propeller unit is mounted is expandable in length.

Furthermore, the propeller support on which the reverse thrust propeller unit is longer than the propeller supports on which the forward thrust propellers are mounted or has the same length as the propeller supports.

Additionally, the reverse thrust propeller unit has a biplane propeller type including an upper propeller and a lower propeller, and the upper propeller and the lower propeller are configured to rotate in opposite directions.

In addition, the drone further includes a load supporting means protruding in a lateral direction of the drone to support a load carried, wherein the flight control unit controls the reverse thrust propeller unit to keep the center of gravity changed by weight of the load loaded on the load supporting means.

Moreover, the load supporting means is expandable in length.

Furthermore, in a first embodiment of the load supporting means, the load supporting means has a multi-stage structure that a cross section of each stage is gradually reduced so that each stage is inserted into or taken out of the inside of another stage with the cross section larger than the cross section thereof.

In this instance, the propeller support on which the reverse thrust propeller unit is mounted serves as the stage with the largest cross section, and the load is loaded at the distal end of the stage with the smallest cross section, and the load is located at the center of gravity of the drone when the length of the load supporting means is minimized.

Additionally, in a second embodiment of the load supporting means, the load supporting means includes: a pair of rails disposed in parallel at a predetermined angle to lower down from a horizontal position; a load receiving box mounted at ends of the rails; a connection member connected with the ends of the rails or the load receiving box; and a rail control unit for spreading or folding the rails by releasing or winding the connection member.

In this instance, the rails have a multi-stage structure that a cross section of each stage is gradually reduced so that each stage is inserted into or taken out of the inside of another stage with the cross section larger than the cross section thereof. The connection member is connected with the ends of the rails or the load receiving box through grooves formed in the rails.

In the second embodiment of the load supporting means, the drone further includes a cover unit arranged on the front side of the load receiving box and disposed to be opened by power that the load receiving box pushes while lowering and to be closed by an elastic body providing constant elastic force.

The cover unit is located below the load receiving box when the load receiving box is opened by the lowering power in order to support the load receiving box.

Moreover, the drone having a reverse thrust balancing function further includes a wind shield unit arranged along the circumference of the reverse thrust propeller to prevent interference of wind.

Furthermore, the wind shield unit is a cylindrical member. Assuming that the direction facing the main body of the drone is the 12 o'clock position, the height of the 3 o'clock position and 9 o'clock position from the top of the cylindrical member is lower than the height of the 12 o'clock position and the 6 o'clock position, and the height gets gradually lower in the 3 o'clock position and 9 o'clock position from the 12 o'clock position and the 6 o'clock position.

Additionally, the drone having a reverse thrust balancing function further includes two or more distance measuring sensors in order to measure a distance between the drone and a vertical wall.

In this embodiment, the flight control unit controls the drone to be perpendicular to the vertical wall according to a distance measured by the distance measuring sensors.

In addition, speed control sensitivity of the drone is adjusted according to the distance measured by the distance measuring sensors.

### Advantageous Effects

As described above, the drone having a reverse thrust balancing function according to the present invention can keep a balance by rapidly offsetting movement of the center of gravity using reverse thrust when the center of gravity of the drone is moved severely in various fields that an object is delivered horizontally, such as a parcel delivery service.

The drone having a reverse thrust balancing function according to the present invention can distribute rotatory power of motors used for making a flight equally so as to promote stable flight, and reduce a danger of falling caused by a great change in the center of gravity according to movement of a load.

Moreover, the drone having a reverse thrust balancing function according to the present invention can be easily controlled to be at right angles to a vertical wall that the drone meets while flying, and be controlled more stably, for instance, controlled in speed control sensitivity when the drone approaches the vertical wall within a predetermined distance.

As described above, the drone having a reverse thrust balancing function according to the present invention is applied to various fields in which the center of gravity changes because of load applied to one side, and thus stable operation of the drone can be promoted.

### DESCRIPTION OF DRAWINGS

FIG. 1 is a view showing a change in the center of gravity of a drone.

FIG. 2 is a view showing a drone according to the present invention.

FIG. 3 is a view showing the drone having five propeller parts.

FIG. 4 is a view showing a biplane structure of a reverse thrust propeller part.

FIG. 5 is a view showing a control of movement of the drone.

FIG. 6 is a view showing performance comparison of reverse thrust propeller supports according to lengths.

FIGS. 7 to 11 are views showing a load supporting means according to a first embodiment of the present invention.

FIGS. 12 to 15 are views showing a load supporting means according to a second embodiment of the present invention.

FIG. 16 is a view showing an example of a wind shield of the reverse thrust propeller.

FIG. 17 is a view showing the drone having a distance measuring sensor.

FIG. 18 is a view showing an example of a method for flying the drone using the distance measuring sensor.

### MODE FOR INVENTION

The invention can be modified in various forms and can have various embodiments. Specific embodiments will be illustrated in the drawings and described in detail.

However, the embodiments are not intended to limit the invention, but it should be understood that the invention includes all modifications, equivalents, and replacements belonging to the concept and the technical scope of the invention. When it is determined that detailed description of known techniques involved in the invention makes the gist of the invention obscure, the detailed description thereof will not be made. The terms used in the following description are intended to merely describe specific embodiments, but not intended to limit the invention.

An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

It will be understood that terms, such as “first” or “second” may be used in the specification to describe various components but are not restricted to the above terms. The terms may be used to discriminate one component from another component.

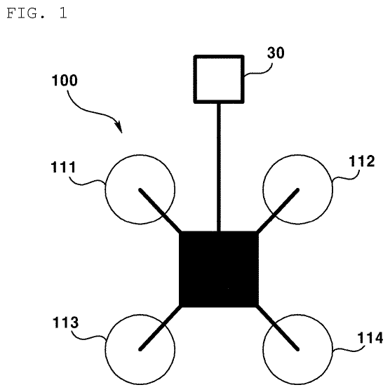

FIG. 1 is a view showing an example that an object 30 is delivered horizontally using a drone 100. It is supposed that motors for operating first to fourth propellers 111 to 114 rotate at speed of 10.

If the drone 100 leans toward the front where the object 30 is located due to a horizontal delivery of the object 30, rotatory power of the motors operating the first to fourth propellers 111 to 114 must be controlled in order to keep horizontality.

In this instance, a strong load is applied to the motors corresponding to the first propeller 111 and the second propeller 112 due to imbalance of the center of gravity, and the motors may not bear the load of the object 30.

For instance, the motors corresponding to the first propeller 111 and the second propeller 112 must be operated at speed of 17 and the motors corresponding to the third propeller 113 and the fourth propeller 114 must be operated at speed of 3, but if the maximum speed of the motors is 15, the drone 100 falls.

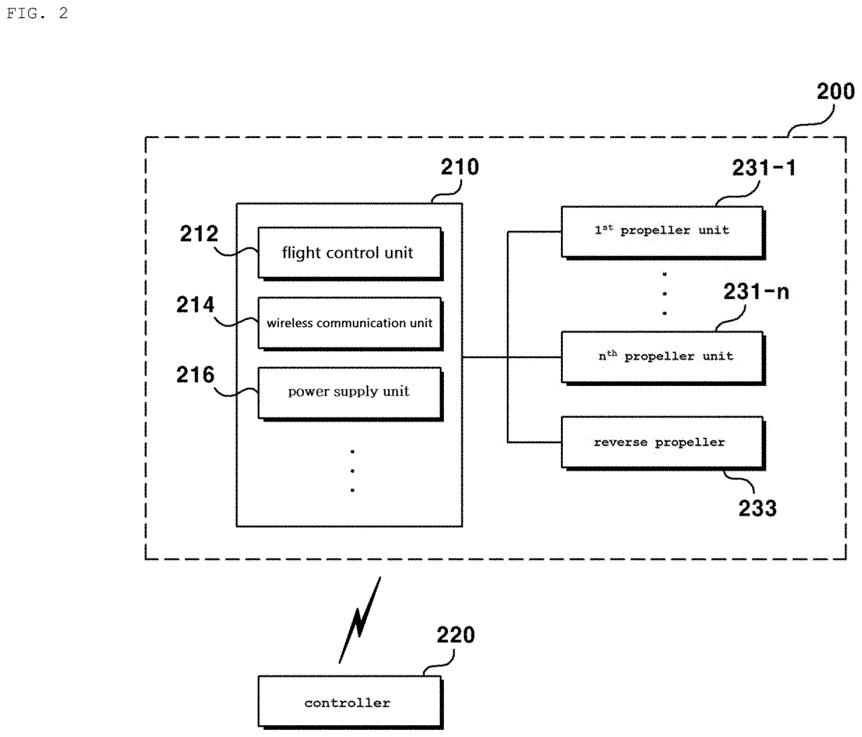

Referring to FIG. 2, the drone 200 according to the present invention includes a main body unit 210 which forms a basic outer case, a plurality of forward thrust propeller units 231-1 to 231-n, and a reverse thrust propeller unit 233.

The drone 200 may have various structures according to applied fields and as occasion demands.

For instance, the drone 200 includes a flight control unit 212 performing overall control related with flight, a wireless communication unit 214 for sending and receiving a control signal wirelessly between the drone 200 and a controller 220, a power supply unit 216 for supplying electric power using a battery, and others. The components may be installed in various ways, and for instance, may be installed in the main body unit 210.

The controller 220 allows a user to control the drone 200 remotely and may have various structures.

The forward thrust propeller units 231-1 to 231-n basically generate power for the drone 200 to stay or move in the air by overcoming gravity.

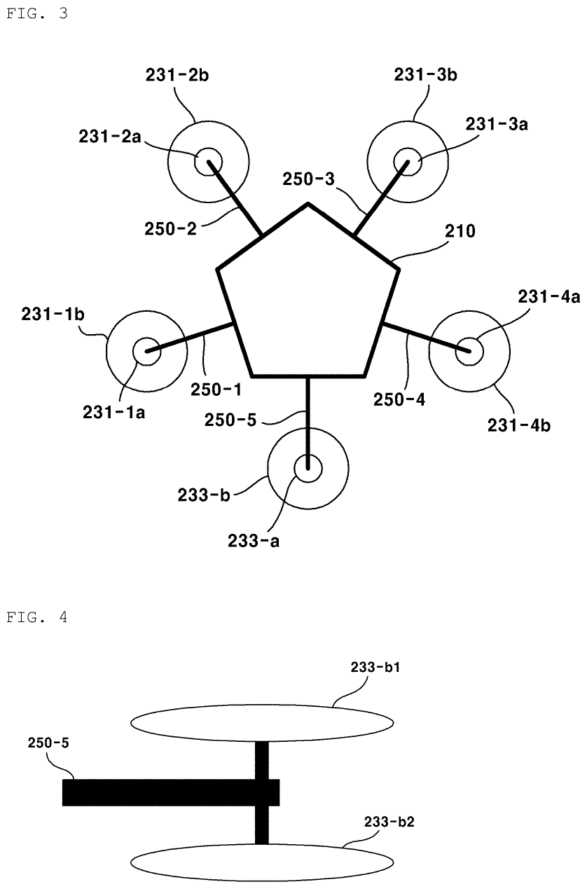

FIG. 3 shows an example of the drone 200 including four forward thrust propeller units 231-1 to 231-4 and one reverse thrust propeller unit 233.

However, the number and arrangement of the forward thrust propeller units may be varied, and there are no restrictions. The forward thrust propeller units 231-1 to 231-4 includes propellers 231-1b to 231-4b forming rotary vanes, and motor units 231-1a to 231-4a for providing the propellers with rotatory power.

The forward thrust propeller units 231-1 to 231-4 are arranged from one another at a predetermined interval through propeller supports 250-1 to 250-4.

The drone 200 according to the present invention includes not only the forward thrust propeller units 231-1 to 231-4 but also a reverse thrust propeller unit 233. The reverse thrust propeller unit 233 includes a propeller 233-b forming a rotary vane and a motor unit 233-a for providing the propeller with rotatory power.

When the forward thrust propeller units 231-1 to 231-4 generate propelling power to make a flight of the drone, the reverse thrust propeller unit 233 generates propelling power to make the drone face the surface of the ground. FIG. 3 illustrates one reverse thrust propeller unit 233, but the number and the location of the reverse thrust propeller unit may be varied.

Furthermore, the flight control unit 212 controls propeller rotation speed of the reverse thrust propeller unit 233 according to a change in the center of gravity of the drone 200. That is, the flight control unit 212 controls power to face the surface of the ground at a position where the reverse thrust propeller unit 233 is mounted.

As described above, the reverse thrust is performed for the following reason. When a strong load is applied to a specific part of the drone 200 and the center of gravity of the drone 200 is changed under a situation like the horizontal delivery of an object, the drone makes a situation similar to that another load is applied to the opposite part in order to distribute power applied to the forward thrust propeller units 231-1 to 231-4 as uniform as possible.

Referring to FIG. 4, the reverse thrust propeller unit 233 may have a biplane propeller type including an upper propeller 233-b1 and a lower propeller 233-b2 in order to offset rotatory power (antitorque) generated from the drone. That is, the biplane form can offset antitorque. In this instance, the upper propeller 233-b1 and the lower propeller 233-b2 are configured to rotate in opposite directions. Even though the upper propeller 233-b1 and the lower propeller 233-b2 rotate in the opposite directions, power of the upper propeller and power of the lower propeller face the surface of the ground.

A propeller support 250-5 on which the reverse thrust propeller unit 233 is mounted may expandable in length. That is, the propeller support 250-5 on which the reverse thrust propeller unit 233 is mounted may get longer or shorter.

The expandable structure of the propeller support 250-5 on which the reverse thrust propeller unit 233 is mounted may be varied. For example, the propeller support 250-5 may have a multi-stage structure, like a fishing rod, that a cross section of each stage is gradually reduced so that each stage is inserted into or taken out of the inside of another stage with the cross section larger than the cross section thereof.

As described above, because the propeller support 250-5 on which the reverse thrust propeller unit 233 is mounted is formed to be expanded or retracted, the location where reverse thrust force is generated gets farther from or closer to the main body unit 210.

Therefore, with the same reverse thrust force, downward power applied for balancing the center of gravity can be bigger or smaller.

### Various Examples of Use of Reverse Thrust

Detailed methods for using reverse thrust when the flight control unit 212 controls flight of the drone 200 will be described.

(1) Reverse thrust does not have any influence on operation of throttle.

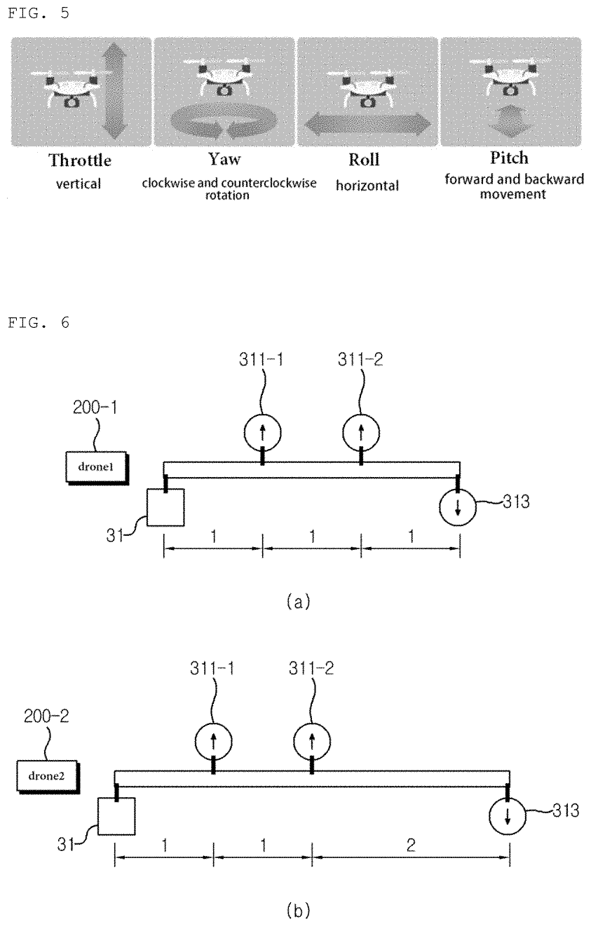

FIG. 5 shows an example of a control direction of the drone based on four channels. A drone control is divided into a manual control that an operator directly controls the drone using the controller 220, and an automatic control that the flight control unit 212 controls the drone by itself using flight control (FC) for hovering.

The reverse thrust propeller may not be influenced by the operation of the throttle during the manual control or the automatic control.

In case of the manual control, the forward thrust propeller gains speed and generates lift force to lift the drone, but the reverse thrust propeller must not be changed in speed regardless of the throttle.

Likewise, also in case of the automatic control, if a drone body ascends or descends for some reason while hovering, the flight control unit 212 lifts or lowers the throttle in order to check base altitude so that the drone ascends or descends. Also in this instance, the reverse thrust propeller should not react to the throttle. If the reverse thrust propeller raise speed according to the throttle, the drone leans toward one side, namely, toward the reverse thrust propeller and loses the center of gravity.

With respect to yaw, roll and pitch except throttle, the flight control unit 212 controls the reverse thrust propeller according to the change in the center of gravity. Especially, the reverse thrust propeller must respond well to pitch since the flight control unit 212 is to prevent the drone from leaning according to the change in the center of gravity.

(2) Reverse thrust propeller operates for posture adjustment of the drone.

When the drone starts up, all propellers including the reverse thrust propeller rotate idly.

When throttle increases in order to lift the drone, the other propellers rotate rapidly and increases lift force to lift the drone.

However, the reverse thrust propeller is not influenced by throttle, and rotates idly at the minimum speed not to generate lift force.

In order to cause hovering of the drone, if it is necessary to control yaw, roll and pitch of the leaned drone, the reverse thrust propeller is actuated.

When the load is moved toward the front of the drone, the drone leans forwards. When an inclination angle is measured by a Gyro sensor, the reverse thrust propeller located at the rear is operated in order to keep a balance of the drone.

If the drone takes off with a heavy thing at the front of the drone, the other propellers rotate in order to lift the drone, but the reverse thrust propeller rotates in order to make the drone leaned by the heavy thing level off.

The rotational speed of the reverse thrust propeller increases till the drone levels off according to the angle of the leaned drone measured by the Gyro sensor. Therefore, when the rotational speed of the reverse thrust propeller is increased regardless of weight of the thing loaded at the front of the drone, horizontality of the drone can be controlled.

(3) Operation of reverse thrust propeller related with movement of drone

The reverse thrust propeller may be operated for movement of the drone as well as for ascent and descent of the drone.

When the drone moves forwards, the propellers located in front of the center of gravity of the drone lower the rotational speed and the propellers behind the center of gravity increase the rotational speed so that the drone moves forwards while leaning forwards. In this instance, the rotational speed of the reverse thrust propeller must be reduced. When the drone moves backwards, contrary to the other propellers, the rotational speed of the reverse thrust propeller must be increased. The drone moves sideways in the same way.

(4) Load bearing performance of drone according to length of the propeller support on which the reverse thrust propeller unit is mounted.

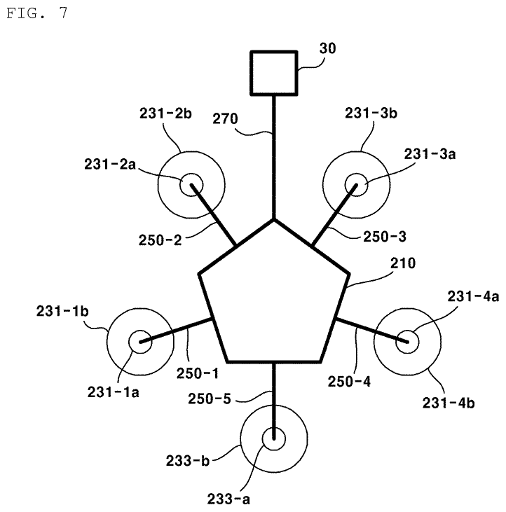

FIG. 6 shows an example that there are different lengths of the propeller support on which the reverse thrust propeller unit is mounted.

FIG. 6a shows an example that a distance between a load 31 and a first propeller 311-1, a distance between the first propeller 311-1 and a second propeller 311-2, and a distance between the second propeller 311-2 and the reverse thrust propeller 313 are the same.

Moreover, FIG. 6b shows an example of a second drone 200-2 that the distance between the second propeller 311-2 and the reverse thrust propeller 313 is doubled.

Here, the first propeller 311-1 and the second propeller 311-2 are forward thrust propellers, and it is assumed that weight of the drone is 2 Kg.

The following tables 1 and 2 show results calculated by ‘Algodoo’ which is a physical simulation program applied to the first drone 200-1 and the second drone 200-2.

In order to check load bearing performance of drone according to length of the propeller support on which the reverse thrust propeller 313 is mounted, assuming that the maximum output of the propellers 311-1, 311-2 and 311-3 is 20, a test was carried out while increasing weight of a load 31 in a state where output of the first propeller 311-1 is fixed to 20.

TABLE 1
(Drone 1- weight: 2 Kg, Unit: 100 g)

| | | | Reverse | Drone |
|---|---|---|---|---|
| Weight of | | | thrust | consumption |
| load | 1^{st} propeller | 2^{nd} propeller | propeller | output |
| 5 | 20 | 5 | 0 | 25 |
| 6 | 20 | 8 | 2 | 30 |
| 7 | 20 | 11 | 4 | 35 |
| 8 | 20 | 14 | 6 | 40 |
| 9 | 20 | 17 | 8 | 45 |
| 10 | 20 | 20 | 10 | 50 |

Referring to Table 1, the maximum load weight of the first drone is 10, and in this instance, the reverse thrust propeller 313 uses power of 10, and consumption output of the drone is 50.

If the first drone does not have the reverse thrust propeller, the maximum load weight of the first drone is 5. Finally, the first drone can carry twice the weight by the reverse thrust propeller 313.

TABLE 2
(Drone 2- weight: 2 Kg, Unit: 100 g)

| | | | Reverse | Drone |
|---|---|---|---|---|
| Weight of | | | thrust | consumption |
| load | 1^{st} propeller | 2^{nd} propeller | propeller | output |
| 10 | 20 | 10 | 0 | 30 |
| 11 | 20 | 12 | 1 | 33 |
| 12 | 20 | 14 | 2 | 36 |
| 13 | 20 | 16 | 3 | 39 |
| 14 | 20 | 18 | 4 | 42 |
| 15 | 20 | 20 | 5 | 45 |

Referring to Table 2, the maximum load weight of the second drone is 15, and in this instance, the reverse thrust propeller 313 uses power of 5, and consumption output of the drone is 45.

If the second drone does not have the reverse thrust propeller, the maximum load weight of the first drone is 10. Finally, the second drone can carry one and a half times the weight by the reverse thrust propeller 313.

Here, to carry the load means that the drone can continuously hover at a predetermined height. That the drone can stay and hover at the predetermined altitude means that lift force for lifting up the drone and force of gravity for lowering down the drone equal each other when the drone ascends to a certain height.

In the Tables 1 and 2, in order to make the lift force and the force of gravity influencing on rise of the drone, the lift force that weight of the drone is subtracted from power of the forward thrust propeller 311-1 and 311-2 causing the lift force must equal reverse thrust force.

For instance, referring to the undermost data of the Table 1, the following results were obtained.

Reverse thrust: load weight (10)+reverse thrust propeller (10)=20

Lift force: 1^{st} propeller (20)+2^{nd} propeller (20)−weight of drone (20)=20

Therefore, reverse thrust force (20) equals lift force (20).

Furthermore, in order to make the drone hover without leaning, power of the left side and power of the right side must balance each other. Of course, pure lift force and thrust force can be obtained when weight of the drone is excluded.

For instance, referring to the undermost data of the Table 2, the following results were obtained.

Left side: load weight (15)−1^{st} propeller (10=20−10 (weight of left half of drone: 20/2))=gravity (5)

Right side: 2^{nd} propeller (10=20-10 (weight of right half of drone: 20/2))−reverse thrust propeller (5)=lift force (5)

Therefore, because the force of gravity (5) of the left side equals the lift force (5) of the right side, the drone can do hovering at the predetermined altitude without ascending and descending due to the balance between the force of gravity and the lift force.

Referring to the Tables 1 and 2, if the reverse thrust propeller is far away from the center of the drone, the drone can carry a heavier load and reduce consumption output so as to effectively use energy.

Referring to such results, the propeller support 250-5 on which the reverse thrust propeller unit 233 is mounted may be formed longer than or have the same length as the propeller supports 250-1 to 250-4 on which the forward thrust propellers are mounted.

In detail, the propeller support 250-5 on which the reverse thrust propeller unit 233 is mounted may be twice longer than the propeller supports 250-1 to 250-4 on which the forward thrust propellers are mounted.

The above examples of use of reverse thrust are to describe examples that reverse thrust is applied to flight of the drone, and the present invention is not restricted to the above.

Now, detailed embodiments for supporting various loads carried by the drone and delivering the loads horizontally will be described.

### First Embodiment of Load Supporting Means

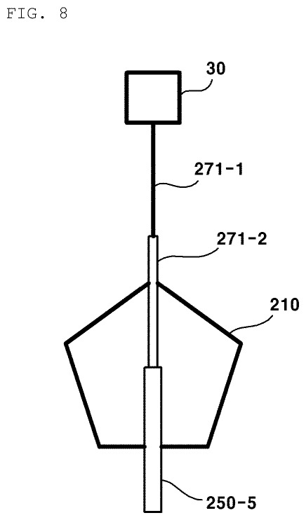

Referring to FIG. 7, the drone 200 includes a load supporting means 270 for supporting the load 30 carried by the drone 200, wherein the load supporting means 270 protrudes in a lateral direction of the drone 200.

Additionally, the flight control unit 212 controls the reverse thrust propeller unit 233 to keep the center of gravity changed by weight of the load 30 loaded on the load supporting means 270.

A distal end portion of the load supporting means 270 is configured in such a way that the load can be attached and detached.

For instance, the load supporting means 270 may have a hook for holding an object at the distal end portion thereof. Then, the drone can carry an object to a veranda of an apartment, and then, can easily do horizontal delivery, for instance, may put it in a basket disposed on the veranda or hang it on a handrail of the veranda.

The load supporting means 270 may be formed to be expandable, or may be formed in various ways.

Referring to FIG. 8, a first embodiment of the expandable load supporting means 270 will be described. The load supporting means 270 may have multiple stages 271-1, 271-2 and 250-5, like a fishing rod, that a cross section of each stage is gradually reduced so that each stage is inserted into or taken out of the inside of another stage with the cross section larger than the cross section thereof.

In this instance, the propeller support 250-5 on which the reverse thrust propeller unit 233 is mounted has the stage with the largest cross section. In this instance, the propeller support 250-5 has a space where the second stage 271-2 is inserted into the propeller support 250-5.

The number, length and form of the stages of the load supporting means 270 may be varied as occasion demands.

The load 30 is loaded at the distal end of the stage 271-1 with the smallest cross section. When the length of the load supporting means is minimized, as shown in FIG. 11, the load 30 is located at the center of gravity of the drone 200. FIG. 11 shows an example of a hook 277 disposed at the distal end of the stage with the smallest cross section to hold the load 30.

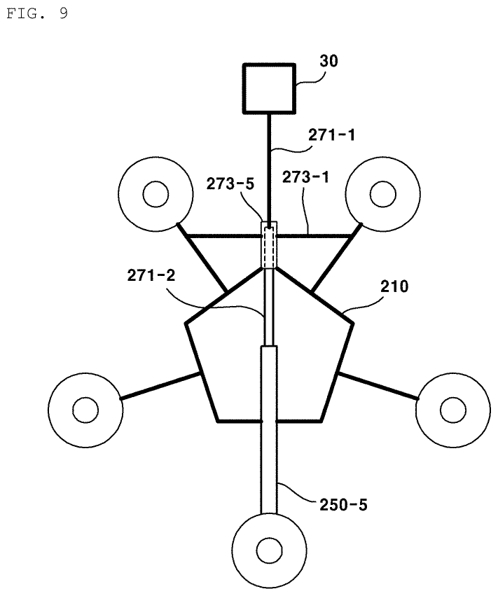

Referring to FIG. 9, in order to properly disperse and bear weight of the load of the expandable load supporting means 270, the load supporting means 270 includes a first support member 273-5 for supporting a part of the load. The first support member 273-5 is fixed by a second support member 273-1 which connects two propeller supports with each other, and the first support member 273-5 is formed to be empty so that the load supporting means 270 can pass through the inner space of the first support member.

Therefore, the first stage 271-1 and the second stage 271-2 of the load supporting means 270 can bear weight of the load 30 well.

The first support member 273-5 may extend to the propeller support 250-5 on which the reverse thrust propeller unit is mounted. That is, the first support member 273-5 may be formed integrally with the propeller support 250-5 on which the reverse thrust propeller unit is mounted.

Moreover, in this embodiment, the first support member 273-5 may have a hole formed at a lower end in a direction that the load 30 is headed so that a part for connecting the distal end of the stage with the smallest cross section of the load supporting means 270 and the hook 277 with each other.

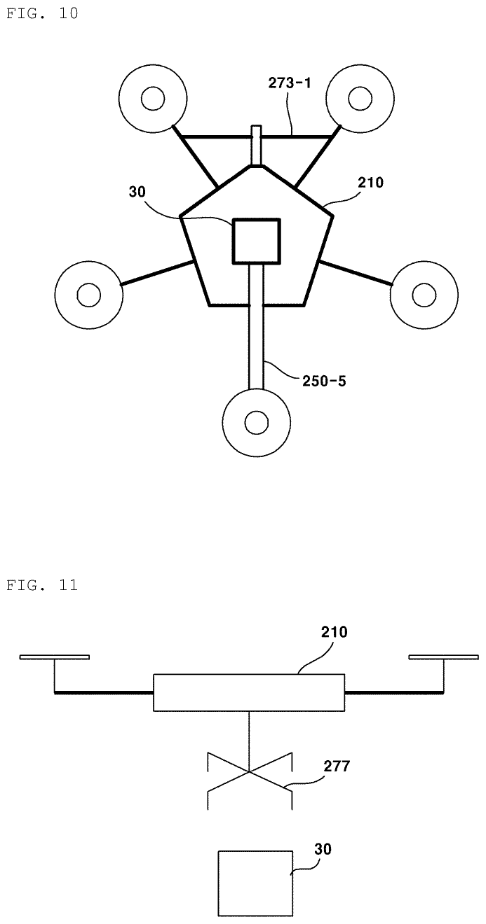

FIG. 10 shows a state where the load supporting means 270 is contracted entirely, and FIG. 11 shows an example that the hook 277 disposed at the distal end of the stage with the smallest cross section holds the load 30. Weight of the load 30 is concentrated on the center of gravity, and the drone 200 can fly to a destination while loading the load 30 thereon.

That is, the drone 200 approaches the destination with the center of gravity located at the central part of the drone 200 while hanging the object onto the hook disposed at the distal end in a state where the load supporting means 270 is folded entirely. Furthermore, when the drone 200 approaches the destination, the load supporting means 270 is expanded to move the object forwards in the horizontal direction, and delivers the object to the handrail of the veranda.

Besides the first embodiment, the load supporting means for delivering the object horizontally may use a robot arm, or may be formed in various ways.

### Second Embodiment of Load Supporting Means

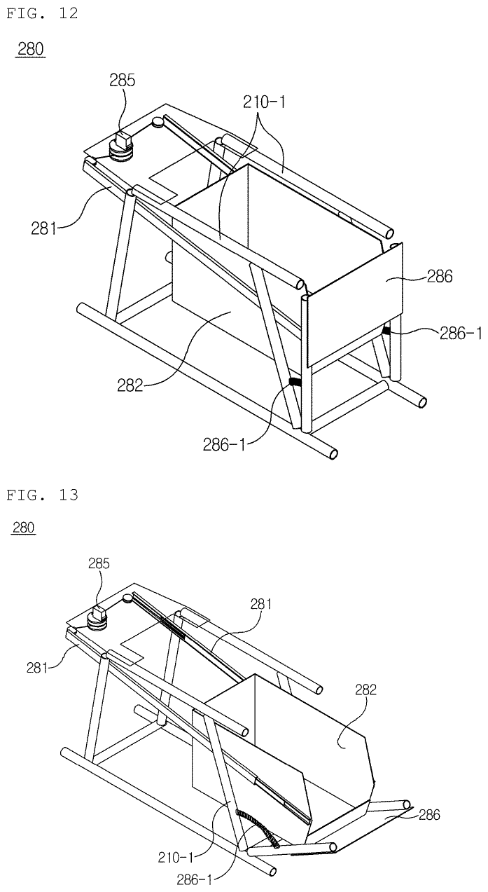

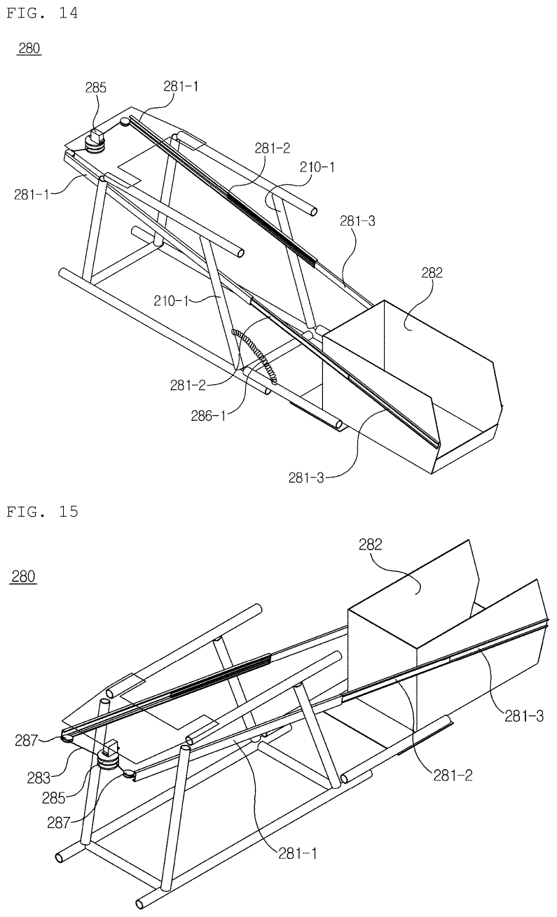

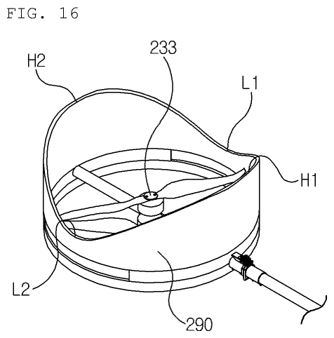

Now, referring to FIGS. 12 to 15, a load supporting means 280 according to the second embodiment will be described.

The load supporting means 280 basically includes a pair of rails 281, a load receiving box 282 mounted at ends of the rails 281, a connection member 283 connected with the ends of the rails or the load receiving box 282, and a rail control unit 285 for spreading or folding the rails 281 by releasing or winding the connection member 283.

The load supporting means 280 may include various frames 210-1 for supporting the components, and a pair of the rails 281 are fixed and mounted on the support frame 210-1 and have the load receiving box 282 mounted at the ends, and are disposed in parallel at a predetermined angle to lower down from a horizontal position. The rails 281 have a multi-stage structure that a cross section of each stage is gradually reduced so that each stage is inserted into or taken out of the inside of another stage with the cross section larger than the cross section thereof.

For the sake of convenient description, an example that the rails 281 have three stages 281-1, 281-2 and 281-3 is illustrated, but the number, form, size, length and structure of stages of the rails 281 may be varied, and are not restricted.

In the three-stage structure, the first stage 281-1 with the largest cross section is mounted on the support frame 210-1, and the load receiving box 282 is mounted at the third stage 281-3 with the smallest cross section.

An object to be delivered is loaded on the load receiving box 282, and the load receiving box 282 of a cuboid shape which has no upper side and of which front side is lower than lateral sides is illustrated in the drawings, but the load receiving box 282 is not restricted to the above and the shape, size, material, and structure may be varied as occasion demands.

The connection member 283 is connected to the ends of the rails or the load receiving box 282, and may be released or wound by the rail control unit 285.

The connection member 283 may be formed in various ways, and as an example, may have a band shape. The rail control unit 285 can release or wind the connection member 283 using a motor.

Because the rails are disposed in parallel at the predetermined angle to lower down from the horizontal position and have the load receiving box 282 mounted at the ends, the rails receive power to be unfolded by gravity. Therefore, when the connection member 283 is released by the rail control unit 285, the rails 281 are unfolded and expanded by gravity. On the other hand, when the connection member 283 is wound by the rail control unit 285, the rails 281 are folded.

That is, the rail control unit 285 controls for the load receiving box 282 mounted at the ends of the rails 281 to ascend or descend.

In the state where all of the rails 281 are folded, when the operator puts an object to be delivered in the load receiving box 282, moves the drone to a destination, and releases the connection member 283 by the rail control unit 285, the rails 281 are expanded and the load receiving box 282 lowers down.

When the load receiving box 282 lowers down to the end, a user to receive the object takes out the object from the load receiving box 282. Then, the rail control unit 285 winds the connection member 283 to fold the rails 281, and then, the drone flies again to return.

There are various methods to connect the connection member 283 between the rail control unit 285 and the load receiving box 282.

For example, at least one connection member 283 may be mounted on the rear surface of the load receiving box 282.

For another example, as shown in the drawings, the connection member 283 may be formed to be connected with the load receiving box 282 through grooves formed in the rails 281. Therefore, the connection member 283 can be formed cleanly to be invisible to the outside.

At least one pulley 287 may be disposed between the rail control unit 285 and the load receiving box 282 to make the connection member 283 move and support smoothly.

Furthermore, a cover unit 286 is disposed on the front side of the load receiving box 282 to cover the inside of the load receiving box 282.

The cover unit 286 is opened by power that the load receiving box 282 pushes while lowering, and is closed by an elastic body 286-1 providing constant elastic force.

In the drawings, the elastic body 286-1 may be a spring, and a pair of elastic bodies 286-1 are connected between the support frame 210-1 and the cover unit 286. Therefore, the elastic bodies 286-1 always apply power to close the cover unit 286 in a direction of the support frame 210-1.

In the state where the rails 281 are folded entirely, when the rail control unit 285 starts to release the connection member 283, the rails 281 are unfolded by gravity and the load receiving box 282 starts to lower down. While the load receiving box 282 pushes the cover unit 286, the cover unit 286 is opened overcoming the elastic force of the elastic body 286-1.

As shown in the drawings, the cover unit 286 is configured to be opened downwardly. When the cover unit 286 is opened, the cover unit 286 is located at a portion adjacent to the bottom side of the load receiving box 282 to support the load of the load receiving box 282.

### Wind Shield Unit of Reverse Thrust Propeller

The reverse thrust propeller unit 233 may be hindered by wind in relation with operation of the drone.

For instance, if the drone moves forwards, because the direction of the wind applied to the reverse thrust propeller is opposite to the direction of wind for reverse thrust, it may have influence on reverse thrust.

In order to prevent such influence, the reverse thrust propeller unit 233 may include a wind shield unit 290, which is arranged along the circumference of the reverse thrust propeller to reduce the influence of wind.

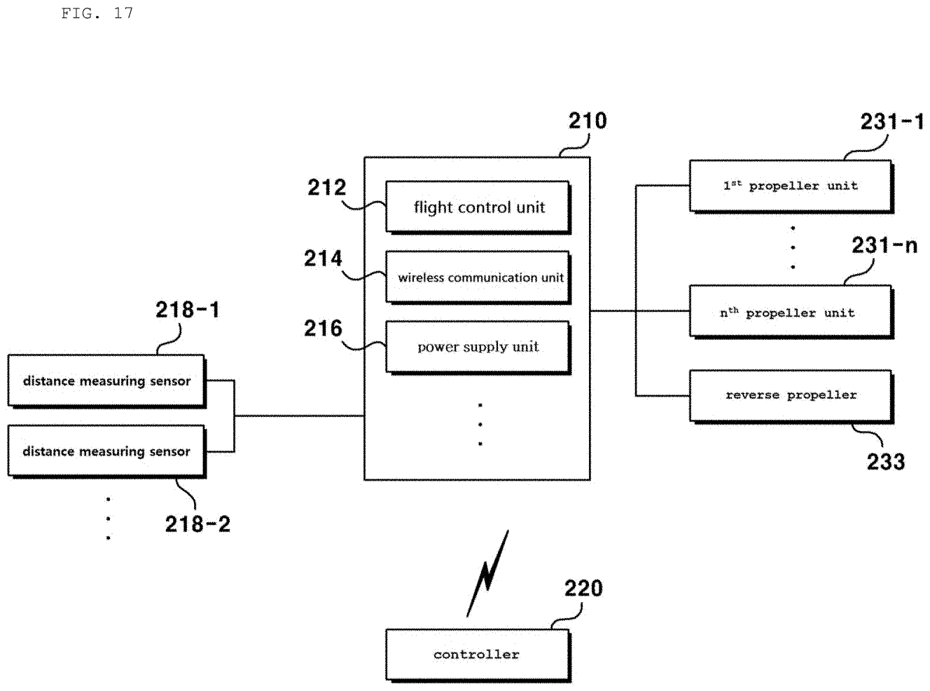

FIG. 16 shows the wind shield unit 290 according to an embodiment, and is a cylindrical member which basically surrounds the reverse thrust propeller, and an upper part of the cylindrical member may be curved.

For instance, assuming that the direction facing the main body of the drone is the 12 o'clock position, the height of the 3 o'clock position (L2) and 9 o'clock position (L1) from the top of the cylindrical member is lower than the height of the 12 o'clock position (H1) and the 6 o'clock position (H2). In this instance, the height gets gradually lower in the 3 o'clock position (L2) and 9 o'clock position (L1) from the 12 o'clock position (H1) and the 6 o'clock position (H2).

Wind facing the reverse thrust propeller from the main body of the drone crosses over the higher part (H1) and gets out to the lower parts (L1 and L2), and some of the wind may cross over the higher part (H2) of the rear side and get out to the rear side. Wind facing the main body of the drone from the outside may also get out in the same way.

As described above, when the influence of the wind applied to the reverse thrust propeller is removed, efficiency of reverse thrust may be increased.

### Forward Rotation of Reverse Thrust Propeller

The reverse thrust propeller unit 233 is basically to generate reverse thrust force, but may generate forward thrust force like the other propeller units in the ordinary way.

For your better understanding, an example of a process of carrying out a parcel delivery service using the drone 200 will be described.

First, an object to be delivered is located at the center of gravity of the drone, the first to fourth propeller units and the reverse thrust propeller unit are all rotated to receive power upwardly, and then, the drone flies to a veranda of an apartment which is a destination.

When the drone arrives at the destination, the object to be delivered is moved slightly forward, and rotation of the reverse thrust propeller unit is stopped. Because the object to be delivered is moved slightly forward and rotation of the reverse thrust propeller unit is stopped, rotational speeds of the first to fourth propeller units can stay the same.

When the reverse thrust propeller unit is rotated in the reverse thrust direction, the drone receives propelling power in the direction of the surface of the ground and moves the object forwards.

Therefore, because a heavy load applied to the front surface of the drone can be offset by the reverse thrust force of the reverse thrust propeller unit, the rotational speeds of the first to fourth propeller units can keep balance.

After the object to be delivered is separated from the load supporting means, the reverse thrust of the reverse thrust propeller unit is stopped, and the load supporting means is inserted into the drone.

Additionally, the reverse propeller unit rotates in the forward rotation direction, the drone moves after hovering by power of all of the five propeller units.

### Prevention of Accidents

Because the parcel delivery service using the drone is carried out in the form of an unmanned service, accidents may occur.

For instance, when the object to be delivered is delivered to a handrail of an apartment, if a child who lives in the apartment approaches the drone or tries to touch the drone, the child or the drone may be damaged.

Therefore, not shown in the drawings, but the drone may include a sensor for checking whether or not a window of the veranda is closed and a speaker to make an announcement. While the object is delivered, when the window of the veranda is opened, the speaker may make an announcement to close the window. Furthermore, the drone may be formed to carry out delivery only when the window is closed after the announcement.

The sensor to check the opened state of the window of the veranda may be one among an infrared sensor, an ultrasonic sensor, and others.

### Control of Angle Between Drone and Wall

The drone is not only used for horizontal delivery of things but also is used in various fields, such as to perform work, namely, cleaning on the wall surface or windows of a building, in a state where a horizontal surface of the drone maintains verticality to an object, for instance, a wall.

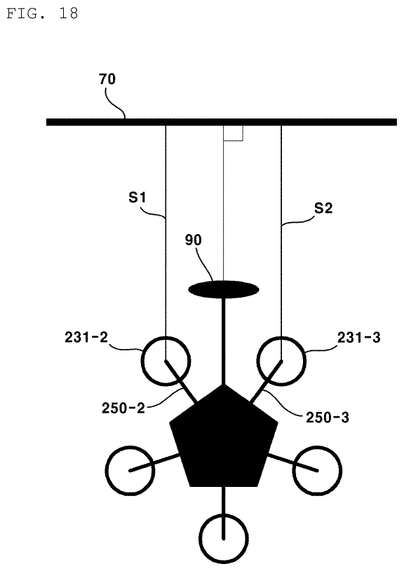

Referring to FIG. 17, the drone 200 may further include two or more distance measuring sensors 218-1 and 218-2 to measure a distance between the drone and the vertical wall.

Distance information measured using the distance measuring sensors 218-1 and 218-2 may be used in various ways, and especially, may be used to decide whether or not the drone 200 is perpendicular to the wall. The distance measuring sensors 218-1 and 218-2 may be realized using various distance measuring methods, such as a method for measuring time that infrared rays are reflected and returned after being irradiated, and a method for calculating a distance after taking a picture using a stereo camera.

In this instance, the flight control unit 212 controls the drone 200 to be perpendicular to the vertical wall according to a distance measured by the distance measuring sensors 218-1 and 218-2.

FIG. 18 shows an example to clean a wall surface 70 of a building. The drone 200 includes a rotary plate 90 to clean the wall 70 in front of the drone 200, and rotates the rotary plate 90 on the wall to clean the wall.

The distance measuring sensors are mounted on the propeller supports 250-2 and 250-3 supporting the two propeller units 231-2 and 231-3, and the flight control unit 212 controls the drone 200 to be perpendicular to the wall 70 according to the distance information S1 and S2 measured by the distance measuring sensors.

In this embodiment, the drone 200 must be perpendicular to the wall 70. However, even though a person controls the drone 200, if a distance between the person and the drone is far, it is not easy to control the drone perpendicularly. In this instance, assuming that a distance between the drone and the wall measured by one among the distance measuring sensors is 250 cm and a distance between the drone and the wall measured by another one among the distance measuring sensors is 200 cm, the drone 200 is not perpendicular to the wall 70.

Therefore, the flight control unit 212 rotates the drone 200 so that the distances between the drone and the wall measured by the distance measuring sensors are the same. Therefore, the flight control unit 212 controls the drone 200 to be perpendicular to the wall 70 to be cleaned.

### Control of Sensitivity Related with Speed Control of Drone

The flight control unit 212 may be formed to control sensitivity related with speed control of the drone 200 according to the distance measured by the distance measuring sensors.

That is, if the drone gets closer to an object to be cleaned, namely, the wall to be cleaned, the drone must be controlled more accurately. So, when the drone gets closer to the destination within a predetermined distance, speed control sensitivity is hebetated so that cleaning work can be carried out more accurately and stably.

For instance, even though an operator controls a stick of the controller 220 so that the drone can move 30 cm, if the drone 200 is located within the predetermined distance from the work place, the controller can control the drone to move about 10 cm by the same control. Such a sensitivity control may be performed by the flight control unit 212 or the controller 220.

While the present invention has been particularly shown and described with reference to exemplary embodiments thereof, these embodiments as described above are only proposed for illustrative purposes and do not limit the present invention. It will be apparent to those skilled in the art that a variety of modifications and variations may be made without departing the spirit and scope of the present invention. Therefore, it is intended that the present invention covers all such modifications provided they come within the scope of the appended claims and their equivalents.

### EXPLANATION OF REFERENCE NUMERALS

100, 200: drone 30: load
210: main body unit 210-1: support frame
212: flight control unit
218-1, 218-2: distance measuring sensor
231-1, 231-n: forward thrust propeller unit
233: reverse thrust propeller unit 220: controller
250-1, 250-5: propeller support
270, 280: load supporting means 277: hook
281: rail 282: load receiving box
283: connection member 285: rail control unit
286: cover unit 286-1: elastic body
287: pulley 290: wind shield unit

1. A drone having a reverse thrust balancing function, which includes a plurality of propellers, comprising:
at least one reverse thrust propeller unit for generating reverse thrust force; and
a flight control unit for controlling rotational speed of the reverse thrust propeller unit according to a change in the center of gravity.

2. The drone according to claim 1, wherein a propeller support on which the reverse thrust propeller unit is mounted is expandable in length.

3. The drone according to claim 1, wherein the propeller support on which the reverse thrust propeller unit is longer than the propeller supports on which the forward thrust propellers are mounted or has the same length as the propeller supports.

4. The drone according to claim 1, wherein the reverse thrust propeller unit has a biplane propeller type including an upper propeller and a lower propeller, and the upper propeller and the lower propeller are configured to rotate in opposite directions.

5. The drone according to claim 1, further comprising:
a load supporting means protruding in a lateral direction of the drone to support a load carried,
wherein the flight control unit controls the reverse thrust propeller unit to keep the center of gravity changed by weight of the load loaded on the load supporting means.

6. The drone according to claim 5, wherein the load supporting means is expandable in length

7. The drone according to claim 6, wherein the load supporting means has a multi-stage structure that a cross section of each stage is gradually reduced so that each stage is inserted into or taken out of the inside of another stage with the cross section larger than the cross section thereof, and the propeller support on which the reverse thrust propeller unit is mounted serves as the stage with the largest cross section, and
wherein the load is loaded at the distal end of the stage with the smallest cross section, and the load is located at the center of gravity of the drone when the length of the load supporting means is minimized.

8. The drone according to claim 6, wherein the load supporting means comprises:
a pair of rails disposed in parallel at a predetermined angle to lower down from a horizontal position;
a load receiving box mounted at ends of the rails;
a connection member connected with the ends of the rails or the load receiving box; and
a rail control unit for spreading or folding the rails by releasing or winding the connection member, and
wherein the rails have a multi-stage structure that a cross section of each stage is gradually reduced so that each stage is inserted into or taken out of the inside of another stage with the cross section larger than the cross section thereof.

9. The drone according to claim 8, wherein the connection member is connected with the ends of the rails or the load receiving box through grooves formed in the rails.

10. The drone according to claim 8, further comprising:
a cover unit arranged on the front side of the load receiving box and disposed to be opened by power that the load receiving box pushes while lowering and to be closed by an elastic body providing constant elastic force.

11. The drone according to claim 10, wherein the cover unit is located below the load receiving box when the load receiving box is opened by the lowering power in order to support the load receiving box.

12. The drone according to claim 1, wherein the reverse thrust propeller unit comprises a wind shield unit arranged along the circumference of the reverse thrust propeller to prevent interference of wind.

13. The drone according to claim 12, wherein the wind shield unit is a cylindrical member, and
wherein assuming that the direction facing the main body of the drone is the 12 o'clock position, the height of the 3 o'clock position and 9 o'clock position from the top of the cylindrical member is lower than the height of the 12 o'clock position and the 6 o'clock position, and the height gets gradually lower in the 3 o'clock position and 9 o'clock position from the 12 o'clock position and the 6 o'clock position.

14. The drone according to claim 1, further comprising:
two or more distance measuring sensors.

15. The drone according to claim 14, wherein the flight control unit controls the drone to be perpendicular to a vertical wall according to a distance measured by the distance measuring sensors.

16. The drone according to claim 14, wherein speed control sensitivity of the drone is adjusted according to the distance measured by the distance measuring sensors.

17. The drone according to claim 2, further comprising: two or more distance measuring sensors.

18. The drone according to claim 3, further comprising: two or more distance measuring sensors.

19. The drone according to claim 4, further comprising: two or more distance measuring sensors.

20. The drone according to claim 5, further comprising: two or more distance measuring sensors.
